(19) United States
(12) Patent Application Publication
(10) Pub. No.: US 2020/0167804 A1
(43) Pub. Date: May 28, 2020

(54) SYSTEMS AND METHODS FOR COMMUNICATING AND ENHANCING LOCAL DATA FOR REMOTE PROCESSING

(71) Applicant: SKUPOS Inc., San Francisco, CA (US)

(72) Inventors: Nam Nguyen, San Francisco, CA (US); Po Chen Lin, Burlingame, CA (US); Richard Woolsey, Foster City, CA (US); Scott Latham, Foster City, CA (US); Garrett Massman, San Francisco, CA (US); Jeffrey Ham, San Francisco, CA (US); Jacob Bolling, Sausalito, CA (US); Michael Glassman, San Francisco, CA (US); Linh Nguyen, Westminster, CA (US)

(73) Assignee: SKUPOS Inc., San Francisco, CA (US)

(21) Appl. No.: 16/200,568

(22) Filed: Nov. 26, 2018

(51) Int. Cl. G06Q 30/02; G06Q 20/20; G06F 16/215; H04L 29/08

(52) U.S. Cl. CPC G06Q 30/0201; G06Q 20/202; H04L 67/26; H04L 67/1097; G06F 16/215

(57) ABSTRACT

First local data is obtained from a first client connected to a central server. The first local data is generated according to a first data format by a first point of sale system connected to the first client. The first point of sale system is associated with a first entity. Second local data is obtained from a second client connected to the central server. The second local data is generated according to a second data format by a second point of sale system connected to the second client. The first and second local data are filtered based on rules. A remote target is identified. Formatted data is generated from the filtered data based on an interface associated with the remote target. The formatted data has a third data format associated with the remote target, and appears to be associated with a single entity. The formatted data is provided to the remote target.

### TECHNICAL FIELD

This disclosure pertains to systems for communicating and enhancing data. More specifically, this disclose pertains to systems for communicating and enhancing local data for remote processing.

### BACKGROUND

Under conventional approaches, a computing system may be limited to local-area networks (LANs) and may be unable to connect to wide-area networks (WANs). For example, a point of sale system in a retail store may only include functionality for communicating over a cable LAN connection to another computing system in the retail store, and may not include functionality for connecting to the Internet or other WANs. Accordingly, such a point of sale system cannot communicate local data generated by the point of sale system to a cloud server, for example, and nor is the local data generated by such a point of sale system intended to be communicated over the Internet and/or processed by a remote system.

### SUMMARY

A claimed solution rooted in computer technology overcomes problems specifically arising in the realm of computer technology. In various embodiments, a computing system is configured to provide a central server system configured to enhance local data obtained from client systems. In some embodiments, the client systems may obtain local data from point of sale systems over respective local-area network (LAN) connections, and then provide the local data to the central server system over a wide-area network (WAN) connection. For example, a first point of sale system (e.g., a Verifone point of sale system) and a corresponding first client system may be located in a first retail store (e.g., “Joe's Store”) owned by a first entity (e.g., “Joe Smith”). The first point of sale system and the first client system may be connected to each other via a LAN connection (e.g., a cable connection). A second point of sale system (e.g., a Gilbarco point of sale system) and a corresponding second client system may be located in a second retail store (e.g., “John's Store”) owned by a second entity (e.g., “John Doe”). The second point of sale system and the second client system may be connected to each other via another LAN connection (e.g., another cable connection). Each of the client systems may provide the local data obtained from their respective point of sale system to the central server system (e.g., via periodic data pushes and/or in response to pull requests). The central server system may also filter and/or format the local data. For example, the central server system may filter the local data to remove duplicate data entries. The central server system may format the local data to correspond to a format required by a target system (e.g., a brand system or a distributor system), and then provide the target-formatted data to the target system.

The computing system may allow, for example, local data obtained from a variety of different retail stores owned by a variety of different owners and using a variety of different point of sale systems to be provided to remote systems as if the different retail stores were a single entity. Furthermore, such local data typically would never reach and/or be processed by remote systems (e.g., brand systems and/or distributor systems), and even if the local data did reach those remote systems, it would not be in the appropriate format for receipt and/or processing by those remote systems. Accordingly, the computing system provides a central system that obtains, stores, and provides local data obtained from disparate, and often distant, point of sale systems in an enhanced format capable of being efficiently received and/or processed by one or more remote systems.

Various embodiments of the present disclosure include systems, methods, and non-transitory computer readable media configured to obtain first local data from a first client system connected to the central server system via a wide-area network (WAN), the first local data generated by a first point of sale system connected to the first client system via a first local-area network (LAN), the first point of sale system being associated with a first owner entity, the first local data being obtained from the first point of sale system by the first client system via the first LAN, and the first local data being generated by the first point of sale system according to a first data format. Second local data is obtained from a second client system connected to the central server system via the WAN, the second local data generated by a second point of sale system connected to the second client system via a second LAN, the second point of sale system being associated with a second owner entity, the second local data being obtained from the second point of sale system by the second client system via the second LAN, and the second local data being generated by the second point of sale system according to a second data format. The first local data and the second local data are filtered based on one or more filtering rules associated with the first point of sale system and the second point of sale system. A first remote target system is identified. At least a portion of the filtered data is selected, the at least a portion of the filtered data including filtered data associated with the first owner entity and filtered data associated with the second owner entity. Target-formatted data is generated from the selected filtered data based on a first interface associated with the first remote target system, the target-formatted data having a third data format associated with the first remote target system, the target-formatted data appearing to be associated with a single owner entity. The target-formatted data is provided to the first remote target system.

In some embodiments, the first client system obtains the first local data using one or more application programming interfaces (APIs) associated with the first point of sale system.

In some embodiments, the second client system obtains the second local data using a file system associated with the point of sale system.

In some embodiments, the first point of sale system and the second point of sale system are not capable of WAN connections.

In some embodiments, the filtering includes removing duplicate data entries from the first local data caused by a periodic pull used by the first client system to obtain the first local data from the point of sale system.

In some embodiments, the second client system obtains the second local data in response to detecting a create event associated with the file system.

In some embodiments, the systems, methods, and non-transitory computer readable media further configured to obtain third local data from the first client system connected to the central server system via the WAN, the third local data generated by a third point of sale system connected to the first client system via the first LAN, the third point of sale system being associated with the first owner entity, the third local data being obtained from the third point of sale system by the third client system via the first LAN, and the third local data being generated by the first point of sale system according to the first data format; filtering the third local data; generating a first report associated with the first and third filtered local data; and providing the first report to an owner system.

In some embodiments, the systems, methods, and non-transitory computer readable media further configured to obtain fourth local data from a third client system connected to the central server system via the WAN, the fourth local data generated by a fourth point of sale system connected to the third client system via a third LAN, the fourth point of sale system being associated with the first owner entity, the fourth local data being obtained from the fourth point of sale system by the fourth client system via the third LAN, and the fourth local data being generated by the fourth point of sale system according to the second data format; filtering the fourth local data; generating, in response to a query received from the owner system, a second report associated with the first filtered local data, the third filtered local data, and the fourth filtered local data; and providing the second report to the owner system.

In some embodiments, the systems, methods, and non-transitory computer readable media further configured to identify a second remote target system; select at least a second portion of the filtered data, the at least a portion of the filtered data including filtered data associated with the first point of sale system, the second point of sale system, the third point of sale system, and the fourth point of sale system; generate second target-formatted data from the second portion of the filtered data based on a second interface associated with the second remote target system, the second target-formatted data having a fourth data format associated with the second remote target system, the second target-formatted data appearing to be associated with the single owner entity; and provide the second target-formatted data to the second remote target system

In some embodiments, the first LAN comprises a first direct cable connection between the first point of sale system and the first client system, and the second LAN comprises a second direct cable connection between the second point of sale system and the second client system.

In some embodiments, the first local data is obtained in response to a periodic pull request during a persistent authenticated session between the first client system and the first point of sale system.

In some embodiments, the first remote target system is identified in response to a request for a report associated with the first remote target system. In some embodiments, the request identifies one or more variables, and the at least a portion of the filtered data is selected based on the one or more variables.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 depicts a diagram of an example network system for communicating and enhancing local data for remote processing, according to some embodiments.

FIG. 2 depicts a diagram of an example of a client system, according to some embodiments.

FIG. 3 depicts a diagram of an example of a central server system, according to some embodiments.

FIG. 4 depicts a diagram of an example of an owner system, according to some embodiments.

FIG. 5 depicts a flowchart of an example method of operation of a central server system, according to some embodiments.

FIG. 6 depicts a flowchart of an example method of operation of a client system connected to an API-based point of sale system, according to some embodiments.

FIG. 7 depicts a flowchart of an example method of operation of a client system connected to a file system-based point of sale system, according to some embodiments.

FIG. 8 depicts a flowchart of an example method of an owner system, according to some embodiments.

FIG. 9 is a diagram of an example computer system for implementing the features disclosed herein, according to some embodiments.

### DETAILED DESCRIPTION

A claimed solution rooted in computer technology overcomes problems specifically arising in the realm of computer technology. In various embodiments, a computing system is configured to provide local data to a central server system configured to enhance the local data obtained from client systems. In some embodiments, the client systems may obtain local data from point of sale systems over respective local-area network (LAN) connections, and then provide the local data to the central server system over a wide-area network (WAN) connection. For example, a first point of sale system (e.g., a Verifone point of sale system) and a corresponding first client system may be located in a first retail store (e.g., “Joe's Store”) owned by a first entity (e.g., “Joe Smith”). The first point of sale system and the first client system may be connected to each other via a LAN connection (e.g., a cable connection). A second point of sale system (e.g., a Gilbarco point of sale system) and a corresponding second client system may be located in a second retail store (e.g., “John's Store”) owned by a second entity (e.g., “John Doe”). The second point of sale system and the second client system may be connected to each other via another LAN connection (e.g., another cable connection). Each of the client systems may provide the local data obtained from their respective point of sale systems to the central server system (e.g., via periodic data pushes and/or in response to pull requests). The central server system may filter and/or format the local data. For example, the central server system may filter the local data to remove duplicate data entries. The central server system may format the local data (e.g., a subset of the local data that is relevant to the target system or to the user of the target system) to correspond to a format required by a target system (e.g., a brand system or a distributor system), and then provide the target-formatted data to the target system.

The computing system may allow, for example, local data obtained from a variety of different retail stores owned by a variety of different owners and using a variety of different point of sale systems to be provided to remote systems as if the different retail stores were a single entity. Further, such local data typically would never reach and/or be processed by remote systems (e.g., brand systems and/or distributor systems), and even if the local data did reach those remote systems, it would not be in the appropriate format for receipt and/or processing by those remote systems. Accordingly, the computing system provides a central system that obtains, stores, and provides local data obtained from disparate, and often distant, point of sale systems in an enhanced format capable of being efficiently received and/or processed by one or more remote systems.

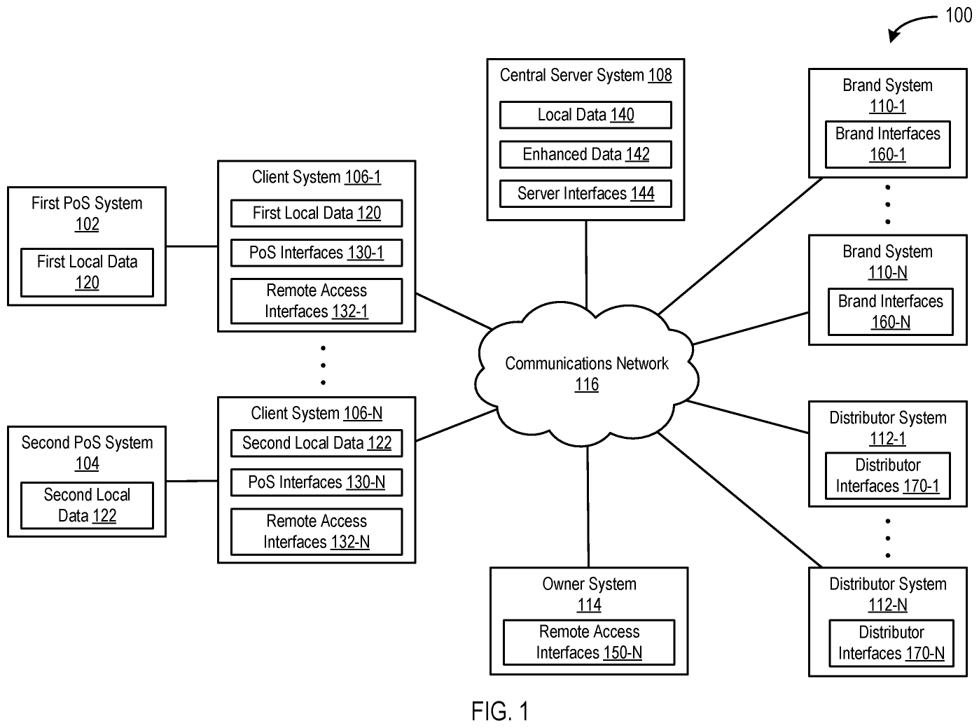

FIG. 1 depicts a diagram of an example network system 100 for communicating and enhancing local data for remote processing according to some embodiments. In the example of FIG. 1, the network system 100 includes a first point of sale system 102, a second point of sale system 104, client systems 106-1 to 106-N (individually, the client system 106, collectively, the client systems 106), a central server system 108, brand systems 110-1 to 110-N (individually, the brand system 110, collectively, the brand systems 110), distributor systems 112-1 to 112-N (individually, the distributor system 112, collectively, the distributor systems 112), an owner system 114, and a communication network 116. While FIG. 1 depicts a single first point of sale system 102, a single second point of sale system 104, and a single owner system 114, this is for illustrative purposes and various embodiments may include any number of such systems.

The first point of sale system 102 may function to generate and/or transmit first local data 120. In various embodiments, functionality of the first point of sale system 102 may be performed by one or more computing devices implementing the first point of sale system 102 (e.g., a Verifone point of sale system). For example, the first point of sale system 102 may be located in a retail store (e.g., a convenience store). In some embodiments, the first point of sale system 102 may be accessed using one or more application programming interfaces (APIs) associated with the first point of sale system 102. For example, Verifone APIs may be used to access the first point of sale system 102 from a computing device connected thereto over a local-area connection (e.g., direct cable connection, local Wi-Fi connection). As used herein, “local data” may be data generated by a system that is not capable of connecting to a wide-area network (WAN). For example, local data may be transaction logs generated by a point of sale system (e.g., point of sale system 102) that is limited to providing transaction logs over local-area connections, and is not capable of accessing the Internet and/or other wide-area network.

In some embodiments, local data may be associated with one or more data formats (or, simply, “formats”) and include content (e.g., text data, image data, audio data). For illustrative clarify, “local data” may refer to first local data 120, second local data 122 (discussed below), local data 140 (discussed below), and/or other local data. Formats may include tabular formats (e.g., tables with columns and rows), object-oriented formats, and/or the like. Formats also may include markup language formats (e.g., XML). Local data may also be associated with a point of sale system. For example, first local data 120 may have a format specific to a type of point of sale system (e.g., Verifone format), and second local data 122 may have a format specific to another type of point of sale system (e.g., Gilbarco point of sale system). Accordingly, local data may include Verifone transaction logs, Gilbarco transaction logs, and/or other types of transaction logs.

The second point of sale system 104 may function to generate and/or transmit second local data 122. In various embodiments, functionality of the second point of sale system 104 may be performed by one or more computing devices implementing the second point of sale system 104 (e.g., Gilbarco point of sale system). In some embodiments, the second point of sale system 104 may generate and/or store second local data 122 in a file system, such as an operating system file system (e.g., a Windows file system). Accordingly, the second point of sale system 104 may be accessed (e.g., to obtain second local data 122) using file system protocols, and may not require specific point of sale system APIs to be accessed.

The client systems 106 may function to obtain first local data 120 and/or second local data 122. In various embodiments, functionality of the client systems 106 may be performed by one or more computing devices (e.g., desktop computers, mobile devices, servers). For example, the client systems 106 may comprise Windows-based computers located in retail stores. In some embodiments, client systems 106 may be connected to one or more first point of sale system 102 and/or one or more second point of sale system 104. For example, client systems 106 may be located in the same retail store as one or more first point of sale systems 102 and/or one or more second point of sale systems 104, and connected thereto by one or more local connections (e.g., a direct cable connection, a local-hub connection, local Wi-Fi connection, and/or the like).

In some embodiments, the client systems 106 may use one or more point of sale system interfaces 130 to access first point of sale systems 102 and/or second point of sale systems 104 (e.g., in order to obtain first local data 120 and/or second local data 122). For example, a first set of a point of sale system interfaces 130 may include API-based point of sale system interfaces (e.g., for accessing first point of sale systems 102) and a second set of point of sale system interfaces 130 may include file system-based point of sale interfaces (e.g., for accessing second point of sale systems 104). The API-based point of sale interfaces 130 may allow the client systems 106 to hook directly into a first point of sale system 102, while the file system-based point of sale interfaces 130 utilize operating system file system APIs and/or protocols to access a file system of the point of sale system 104.

In some embodiments, the client systems 106 function to receive and/or establish secure remote access connections with one or more remote systems over a communication network. For example, the client systems 106 may function to receive and/or establish virtual private network (VPN) connections (or, “tunnels”) with one or more remote systems over communication network 116. The secure remote access connections may, for example, allow a remote user to interact with the client systems 106 as if the remote user were on site at the physical location of the clients system 106 (e.g., the retail store including the client system 106). Additionally, the secure remote access connections may allow a remote user to access different client system 106 without having to physically travel to each of the retail stores including those client system 106.

The central server system 108 may function to obtain local data 140. Local data 140 may include first local data 120 and/or second local data 122. In various embodiments, functionality of the central server system 108 may be performed by one or more servers (e.g., a cloud-based server) and/or other computing devices. The central server system 108 may obtain local data 140 over a communications network (e.g., communications network 116). In some embodiments, the central server system 108 may use one or more central server system interfaces 144 to communicate with client systems 106 to obtain local data 140. The central server system interfaces 144 may include application programming interfaces (APIs), software development kits (SDKs), source code, machine code, and/or server stubs. Accordingly, the central server system interfaces 144 may include files (e.g., source code files), documents, executables, and/or the like.

The central server system 108 may function to generate and/or transmit enhanced data 142 from local data 140. Enhanced data 142 may, for example, allow the central server system 108 to store in a central location data configured for receipt by one or more remote target systems, rather than in many disparate formats that would otherwise be unable or more complicated to be received and/or processed by the remote systems. In some embodiments, enhanced data 142 may appear to be associated with a single owner entity, instead of the multiple owner entities associated with the local data 140 used to the generate the enhanced data 142.

In some embodiments, the central server system 108 may filter and/or format local data 140 to generate enhanced data 142. For example, local data 140 may include duplicate entries, and may have a variety of different formats. The central server system 108 may identify and delete duplicate entries and/or remove, anonymize, and/or modify owner entity information. For example, the central server system 108 may modify transaction logs to indicate a single owner entity (e.g., Skupos).

In some embodiments, the central server system 108 may format local data 140, and/or filtered local data, to have a common format (e.g., a normalized XML, format). For sake of illustrative clarity, it will be appreciated that functions (e.g., filtering) performed on local data, as described herein, may also be applied to filtered data and vice versa. In some embodiments, the central server system 108 may format the local data 140 based on an intended target system for the local data 140. For example, the local data 140 may include transaction logs for a variety of different retail stores, and the intended target may be a remote Coca-Cola system. The central server system 108 may format that local data 140 according to a specification defined by the target system. For example, the central server system interfaces 144 may include the specifications for various target systems, and the central server system 108 may format each respective subset of local data 140 using the central server system interfaces 144.

The central server system 108 may function to generate reports. As used herein, reports may comprise a particular type of enhanced data 142. For example, reports may include summaries of transactions logs, and the reports may be formatted according to requirements of an intended target system (e.g., a brand system and/or distributor system). In another example, reports may be generated for an owner system (e.g., so the owner may view transaction logs, transaction log summaries, and/or the like). The central server system 108 may generate reports based on local data 140, filtered local data, and/or normalized local data.

The brand systems 110 may function to obtain and process reports and/or other data configured according to their system requirements. For example, a brand system 110 may be associated with Coca-Cola. In some embodiments, the brand systems 110 may use brand interfaces 160 to connect to one or more datastores of the central server system 108 to obtain the enhanced data and/or reports. In another example, the brand systems 110 may provide a request for reports to the central server system 108, and the central server system 108 may generate and provide reports in response to the request. In another example, reports may be provided to brand systems 110 as they are created. In various embodiments, functionality of the brand systems 110 may be performed by one or more servers (e.g., a cloud-based server) and/or other computing devices.

The distributor systems 112 may function to obtain and process reports and/or other data configured according to their system requirements. The distributor systems 112 may obtain and process reports and/or other data in connection with distribution of products (e.g., soda) associated with brands (e.g., Coca-Cola). In some embodiments, the distributor systems 112 may use distributor interfaces 170 to connect to one or more datastores of the central server system 108 to obtain reports. In another example, the distributor systems 112 may provide a request for reports to the central server system 108, and the central server system 108 may generate and provide reports in response to the request. In another example, reports may be provided to distributor systems 112 as they are created. In various embodiments, functionality of the distributor systems 112 may be performed by one or more servers (e.g., a cloud-based server) and/or other computing devices.

The owner system 114 may function to manage and/or otherwise interact with remote systems (e.g., client systems 106). For example, an owner entity may own multiple retail stores, and each store may have a client system 106. The owner system 114 may use a remote access interface 150 to establish and/or initiate a secure remote connection with a particular client system 106 to pull transaction logs from associated point of sale systems, view those transactions, request that corresponding reports be generated, and/or the like. The owner system 114 may display information (e.g., reports) via a dashboard and/or other graphical user interfaces. In various embodiments, functionality of the owner system 114 may be performed by one more computing devices (e.g., desktop computer, mobile devices, servers).

The communications network 116 may represent one or more computer networks (e.g., LAN, WAN, or the like) or other transmission mediums. The communication network 116 may provide communication between some or all of the systems, engines, datastores, and/or other features described herein. For example, the communications network 116 may provide communication between the systems 106-114, but not system 102-104 (e.g., because the point of sale systems 102 and 104 may be limited to non-WAN connections). In some embodiments, the communication network 116 includes one or more computing devices, routers, cables, buses, and/or other network topologies (e.g., mesh, and the like). In some embodiments, the communication network 116 may be wired and/or wireless. In various embodiments, the communication network 116 may include the Internet, one or more wide area networks (WANs) or local-area networks (LANs), one or more networks that may be public, private, IP-based, non-IP based, and so forth.

In some embodiments, it may be possible for the point of sale systems 102 and/or 104 to communicate over the communication network 116, and for the central server system 108 to communicate directly with the point of sale systems 102 and/or 104 without any intermediate client systems 106. In such embodiments, some or all of the functionality provided at the client systems 106 may be integrated into the central server system 108.

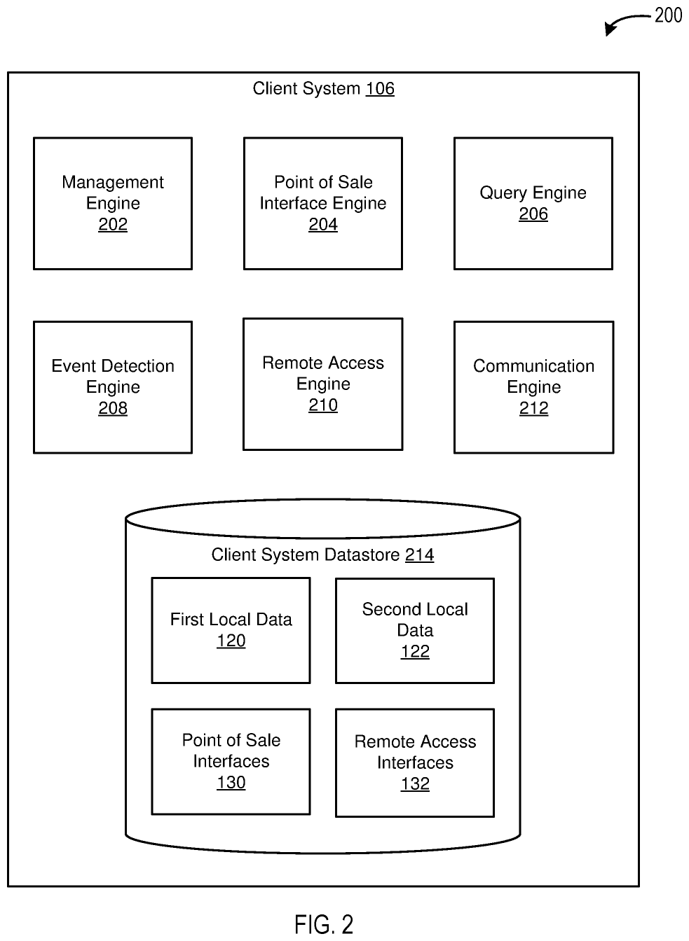

FIG. 2 depicts a diagram of an example client system 106 according to some embodiments. In the example of FIG. 2, the client system 106 includes a management engine 202, a point of sale interface engine 204, a query engine 206, an event detection engine 208, a remote access engine 210, a communication engine 212, and a client system datastore 214.

The management engine 202 may function to manage (e.g., create, read, update, delete, or otherwise access) first local data 120, second local data 122, point of sale interfaces 130, and/or remote access interfaces 132. Any of 120-132 may be stored in the client system datastore 214 and/or other datastore(s) associated with the client system 106. The management engine 202 may perform any of these operations manually (e.g., by a user interacting with a GUI) and/or automatically (e.g., triggered by one or more of the engines 204-212). Like other engines described herein, some or all of the functionality of the management engine 202 may be included in and/or cooperate with one or more other engines (e.g., engines 204-212).

The point of sale interface engine 204 may function to access point of sale systems. For example, the point of sale interface engine 204 may use HTTP protocols to access first point of sale systems 102 and/or second point of sale systems 104 over a LAN connection. In some embodiments, the point of sale interface engine 204 may access point of sale systems using point of sale interfaces 130. For example, the point of sale interfaces 130 may include APIs, file system protocols, authentication information for logging into the point of sale systems, and/or the like.

In some embodiments, authentication information may include credentials specific to a point of sale system (e.g., Verifone username and password) and/or operating system credentials (e.g., a Windows username or password). The point of sale interface engine 204 may authenticate information defined in a point of sale interface 130 against a point of sale system. In some embodiments, a cookie or other session token may be generated, which may be renewed and/or refreshed by the point of sale interface engine 204 to maintain a persistent (or, semi-persistent) connection between a client system and one or more point of sale systems.

In some embodiments, the query engine 206 may function to obtain local data from point of sale systems. For example, the query engine 206 may obtain first local data 120 from a connected first point of sale system 102 over a local-area network connection, and second local data 122 from a second point of sale system 104 over a local-area network connection. In some embodiments, the point of sale interface engine 204 may periodically pull local data from point of sale systems. For example, the point of sale interface engine 204 may pull local data every 15 minutes and/or other predetermined period and/or schedule. In one example, the query engine 206 system may pull first local data 120 corresponding to chunk of time (e.g., an 8 hour shift) every 15 minutes. This may result in redundant data which the central server system may filter, as discussed elsewhere herein.

The query engine 206 may function to obtain local data on-demand. For example, the query engine 206 may receive a request to pull local data. The request may include a client system identifier (e.g., computer name, MAC address, an IP address), a retail store identifier (e.g., name or other identifier), a type of transaction (e.g., sale transaction), a point of sale identifier (e.g., system ID number, IP address, MAC address), transaction log file names, and/or desired time and date ranges. In some embodiments, point of sale systems may not store local data according to time and/or data ranges. Accordingly, the query engine 206 may generate a query based on a desired time and/or data range. For example, the request may include “August 2017,” and the query engine 206 may generate a request for transaction log files having a file name including “August” and “2017.” In another example, query engine 206 may search content of local data for field values having “August” or “2017,” and/or corresponding numerical information (e.g., Aug. 15, 2017).

The query engine 206 may function to obtain local data in response to an event. In some embodiments, the event detection engine 208 may function to detect events in file system-based point of sale systems (e.g., point of sale systems 104). For example, the query engine 206 may listen for, and/or detect, a create event (or other file system event). In response to detecting the create event, the detection engine 208 may notify the query engine 206 to connect directly to the file system folder containing the created data (e.g., second local data), and pull the data. This may, for example, ensure that data is pulled immediately after being generated, and may also reduce and/or prevent duplicate data.

The remote access engine 210 may function to receive and/or establish secure remote access connections. For example, the remote access engine 210 may function to receive and/or establish virtual private network connections. The secure remote access connections may allow a remote user to interact with the client system 106 as if the remote user were on site at the location of the client system 106. In some embodiments, the remote access engine 210 may use a remote access interface 132 to cooperate with a corresponding remote access interface on a remote system to establish and/or maintain the secure remote access connection.

The communication engine 212 may function to send requests, transmit and, receive communications, and/or otherwise provide communication with one or a plurality of the systems, engines, and/or datastores described herein. In some embodiments, the communication engine 212 functions to encrypt and decrypt communications. The communication engine 212 may function to send requests to and receive data from one or more systems through a network or a portion of a network. Depending upon implementation-specific considerations, the communication engine 212 may send requests and receive data through a connection, all or a portion of which may be a wireless connection. The communication engine 212 may request and receive messages, and/or other communications from associated systems and/or engines. Communications may be stored in the client system datastore 214.

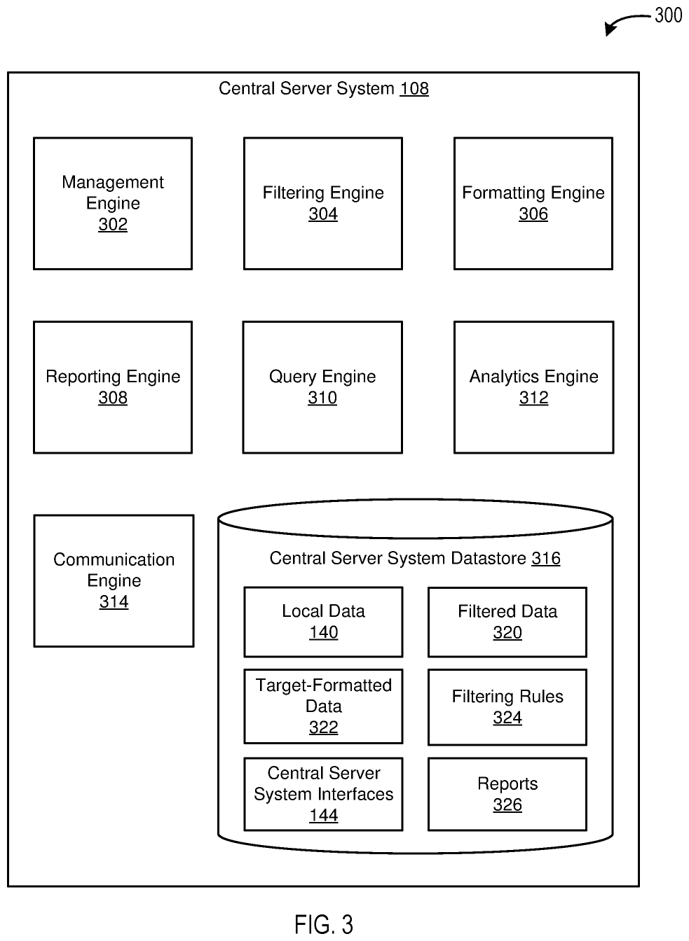

FIG. 3 depicts a diagram of an example central server system 108 according to some embodiments. In the example of the FIG. 3, the central server system 108 includes a management engine 302, a filtering engine 304, a formatting engine 306, a reporting engine 308, a query engine 310, an analytics engine 312, a communication engine 314, and a central server system datastore 316.

The management engine 302 may function to manage (e.g., create, read, update, delete, or otherwise access) local data 140, filtered data 320, target-formatted data 322, filtering rules 324, central server system interfaces 144, and/or reports 326, any of which may be stored in the central server system datastore 316 and/or other datastore(s) associated with the central server system 108. In some embodiments, the filtered data 320, the target-formatted data 322, and/or the reports 326 may be referred to as enhanced data. The management engine 302 may perform any of these operations manually (e.g., by a user interacting with a GUI) and/or automatically (e.g., triggered by one or more of the engines 304-314). Like other engines described herein, some or all of the functionality of the management engine 302 may be included in and/or cooperate with one or more other engines (e.g., engines 304-314).

The filtering engine 304 may function to filter local data 140 to generate filtered data 320. Local data 140 may include first local data 120 and/or second local data 122. Accordingly, the local data 140 may include tabular data, e.g., a column indicating an owner entity identifier, a column indicating a consumer entity, a column indicating a product identifier (e.g., UPC code), a column indicating a store identifier (e.g., a retail store identifier), and/or the like. The filtering engine 304 may filter local data 140 to remove duplicate data entries, and/or remove particular entries and/or particular fields (e.g., columns of tabular data). For example, the filtering engine 304 may remove columns indicating an entity owner. In another example, the filtering engine may modify values associated with an entity owner identifier to a common value (e.g., “Skupos”). Similar functionality may be included in the reporting engine 308, discussed further herein, to similarly modify, filter, and/or generate reports (e.g., so that reports 326 may appear to associated with a single owner entity).

In some embodiments, the filtering engine 304 may identify duplicate entries based on direct field matches and/or direct field value matches. For example, the filtering engine 304 may compare tables, columns, and/or rows, and if there is an exact match, the filtering engine 304 may identify a duplicate and merge the entries and/or delete duplicates until there are no more duplicates remaining. In some embodiments, the filter engine 304 may infer duplicates. For example, local data may be obtained in different formats, and it may appear that entries are different when in fact they are duplicates. The filtering engine 304 may normalize the local data prior to identifying the duplicates, as the normalization may surface duplicates that would otherwise appear different (e.g., because they are in different formats prior to the normalization).

In some embodiments, the filtering engine 304 may filter local data 140 based on filtering rules 324. The filtering rules 324 may define rules for removing and/or modifying fields (e.g., columns, rows, tables) and/or field values, identifying duplicate entries, resolving duplicate entries, and/or the like. The filtering rules 324 may also be associated with particular point of sale systems. For example, a first set of rules 324 may be associated with a first point of sale system 102 and a second set of rules 324 may be associated with a second point of sale system 104. The first set of rules may be configured for a primarily pull-based client system, which can cause many duplicate entries, and the second set of rules 324 may be configured for a primarily event-based client system, which may cause fewer duplicate entries. For example, the first set of rules 324 may cause the filtering engine 304 to identify and resolve duplicates for all obtained local data obtained from a first point of sale system 102, but only identify and resolve duplicates for a particular subset of local data obtained from a second point of sale system 104. For example, if the second point of sale system 104 obtained the local data in response to detecting an event, the filtering engine 304 may not check for duplicates, although the filtering engine 304 may check for duplicates if the second point of sale system 104 obtained the local data in response to a periodic pull.

The formatting engine 306 may function to format local data 140 and/or filtered data 320 to generate target-formatted data 322. In some embodiments, the formatting engine 306 may normalize data (e.g., local data 140 and/or filtered data 320), and format the normalized data to generate the target-formatted data 322. The formatting engine 306 may generate target-formatted data 322 based on requirements of one of one or more remote target system and/or entities associated therewith (e.g., Coca-Cola). In some embodiments, the formatting engine 306 may use central server system interfaces 144 to generate target-formatted data 322. For example, the central server system interfaces 144 may define requirements for structuring data (e.g., table structure, field names, data types, values, and/or the like), amount of data to include, a particular XML structure, and/or the like, associated with particular remote systems.

In some embodiments, the formatting engine 306 may parse local data 140 and/or filtered data 320 to parse out specific data required and/or excluded by a remote target system (e.g., as defined by a central server system interface 144). For example, the formatting engine 306 may parse data to select and/or exclude owner entity identifiers, consumer entity identifiers, product identifiers (e.g., UPC codes), store identifiers, and/or the like.

The reporting engine 308 may function to generate reports 326. For example, reports 326 may comprise transactions logs, summaries of transactions logs, and/or the like. Summaries may include information describing a set of transactions logs (e.g., total transaction amounts, transaction amount averages, transaction trends, and/or the like). Reports 326 may be configured by the reporting engine 306 for receipt by a remote target system. Reports 326 may be configured to be provided to brand systems, distributor systems, owner systems, and/or other systems. Reports may be configured to appear as if they are associated with a single entity.

In some embodiments, the reporting engine 308 receives a request for a report, e.g., from a brand or from a distributor. For example, a distributor may want to want to know how many items were sold in the state of Oregon and/or in a northwest region of the United States, and the corresponding report may indicate that information in one or more varying levels of granularity and/or in the format defined in the interface associated with the target system. In some embodiments, the report request may specify one or more variables, e.g., manufacturer, brand, product type, product category, retail store identifier, geographic location, and/or specific set of uniform product codes (UPCs). The reporting engine 308 may generate a report based on the request. The report may be based on the relevant subset of the local data 140 and/or filtered local data 320.

The query engine 310 may function to obtain local data 140. The query engine 310 may use web sockets to communicate and/or instruct client systems. The query engine 310 may instruct a client system to pull local data from a connected point of sale system. The query engine 310 may obtain local data in response to receiving a request for local data from a remote system. In some embodiments, the query engine 310 functions to process requests. For example, the query engine 310 may function to process requests for previously generated and/or stored reports 326, and/or generate new reports 326.

The analytics engine 312 may function to analyze local data 140, filtered data 320, target-formatted data 322, and/or reports 326. In some embodiments, the analytics engine 312 may determine dates and/or times that a retail store is closed. For example, the analytics engine 312 may analyze local data 140 and determine that local data for Sundays are always empty, and the analytics engine 312 may determine that the store associated with that local data is closed on Sundays. In some embodiments, this may cause the central server system 108 to update when a corresponding client system pulls local data from the point of sale system(s) in that store (e.g., only pull data on Monday through Saturday).

The communication engine 314 may function to send requests, transmit and, receive communications, and/or otherwise provide communication with one or a plurality of the systems, engines, and/or datastores described herein. In some embodiments, the communication engine 314 functions to encrypt and decrypt communications. The communication engine 314 may function to send requests to and receive data from one or more systems through a network or a portion of a network. Depending upon implementation-specific considerations, the communication engine 314 may send requests and receive data through a connection, all or a portion of which may be a wireless connection. The communication engine 314 may request and receive messages, and/or other communications from associated systems and/or engines. Communications may be stored in the central server system datastore 316.

In some embodiments, the communication engine 314 obtains local data 140 from client systems over a communication network. For example, the communication engine 314 may obtain local data 140 pushed to the central server system 108 from the clients systems, and/or pull data from client systems (e.g., in response to query generated and/or processed by the query engine 310).

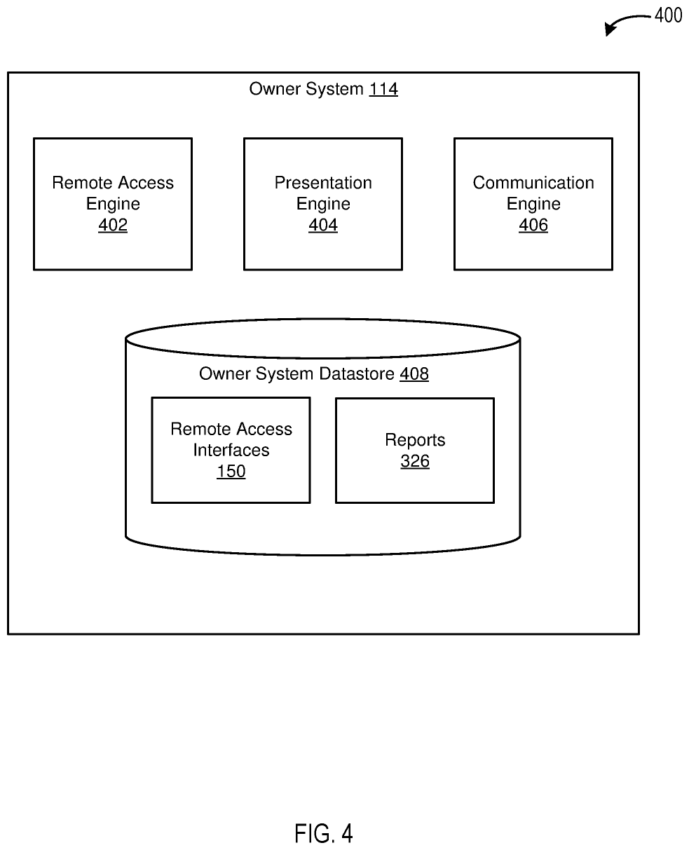

FIG. 4 depicts a diagram of an example owner system 114 according to some embodiments. In the example of the FIG. 4, the owner system 114 includes a remote access engine 402, a presentation engine 404, a communication engine 406, and an owner system datastore 408.

The remote access engine 402 may function to establish secure remote connections with one or more client systems. In some embodiments, the remote access engine 402 uses remote access interfaces 150 to establish secure remote connections. For example, the remote access engine 402 may establish a virtual private network connection with one or more client systems in one or more locations.

The presentation engine 404 may function to present and/or display one or more dashboards and/or graphical user interfaces. For example, a dashboard may allow a user (e.g., entity owner) to view reports 326, request reports 326, view local data on client systems, request client systems to obtain local data from point of sale systems, and/or the like.

The communication engine 406 may function to send requests, transmit and, receive communications, and/or otherwise provide communication with one or a plurality of the systems, engines, and/or datastores described herein. In some embodiments, the communication engine 406 functions to encrypt and decrypt communications. The communication engine 406 may function to send requests to and receive data from one or more systems through a network or a portion of a network. Depending upon implementation-specific considerations, the communication engine 406 may send requests and receive data through a connection, all or a portion of which may be a wireless connection. The communication engine 406 may request and receive messages, and/or other communications from associated systems and/or engines. Communications may be stored in the owner system datastore 408.

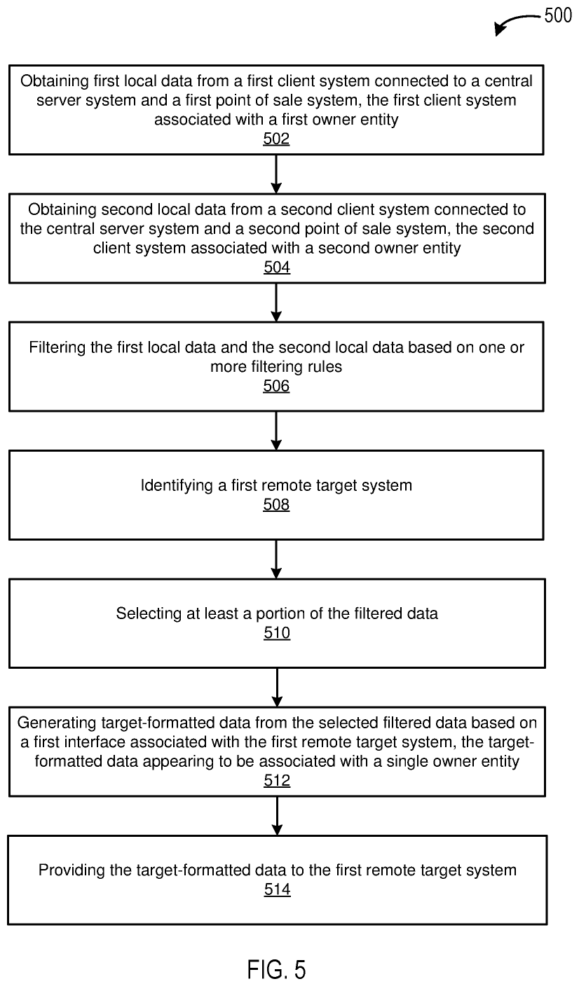

FIG. 5 depicts a flowchart of an example of a method 500 of operation of a central server system according to some embodiments. In this and other flowcharts and/or sequence diagrams, the flowchart illustrates by way of example a sequence of steps. It should be understood the steps may be reorganized for parallel execution, or reordered, as applicable. Moreover, some steps that could have been included may have been removed to avoid providing too much information for the sake of clarity and some steps that were included could be removed, but may have been included for the sake of illustrative clarity.

In step 502, a central server system (e.g., central server system 108) obtains first local data (e.g., first local data 120) from a first client system (e.g., client system 106-1) connected to the central server system via a wide-area network (e.g., communications network 116). The first local data may be generated by a first point of sale system (e.g., first point of sale system 102) connected to the first client system via a first local-area network (e.g., a direct cable connection). For example, the first point of sale system may be a Verifone point of sale system located in a retail store (e.g., “Joe's Store”) owned by a first owner entity (e.g., “Joe Smith”). The first local data may be obtained from the first point of sale system by the first client system via the first LAN. The first local data may be generated by the first point of sale system according to a first data format. For example, the first data format may be a mark-up language format (e.g., XML), a data format associated with Verifone point of sale systems, and/or the like. The first data format may be a tabular format, object-oriented format, and/or the like. In some embodiments, a query engine (e.g., query engine 314) and/or a communication engine (e.g., communication engine 314) obtains the first local data from the first client system.

In some embodiments, the first local data is obtained by the first client system using one or more application programming interfaces (APIs) associated with the first point of sale system. For example, the first client system may use one or more Verifone APIs to hook into the first point of sale system (e.g., as opposed to a file system that may be accessed using operating system protocols) to obtain the first local data from the first point of sale system.

In some embodiments, the first local data is obtained in response to a periodic pull request generated by the first client system and/or the central server system. For example, the first client system may pull first local data corresponding to chunk of time (e.g., an 8 hour shift) every 15 minutes. This may result in redundant (or, “duplicate”) data which the central server system may filter, as discussed elsewhere herein.

In some embodiments, the first local data is obtained in response to a periodic pull request during a persistent authenticated session between the first client system and the first point of sale system. For example, the first client system may log-in with credentials associated with the first point of sale system which may be authenticated against the first point of sale system by the first point of sale system. A cookie or other session token may be renewed or refreshed by the first client system to maintain a persistent connection between the first client system and the first point of sale system. In some embodiments, a point of sale interface engine (e.g., point of sale interface engine 204) performs log-ins, authentications, and/or maintains the persistent connection.

In step 504, the central server system obtains second local data (e.g., second local data 122) from a second client system (e.g., client system 106-N) connected to the central server system via the WAN. The second local data may be generated by a second point of sale system (e.g., second point of sale system 104) connected to the second client system via a second LAN (e.g., a direct cable connection). For example, the second point of sale system may be a Gilbarco point of sale system located in another retail store (e.g., “John's Store”) owned by a second owner entity (e.g., “John Doe”). The second local data may be obtained from the second point of sale system by the second client system via the second LAN. The second local data may be generated by the second point of sale system according to a second data format. For example, the second data format may be a mark-up language format (e.g., XML), a data format associated with Gilbarco point of sale systems, and/or the like. The second data format may be a tabular format, object-oriented format, and/or the like. The second data format be different and/or the same as the first data format. In some embodiments, the query engine and/or the communication engine obtains the second local data from the second client system.

In some embodiments, the second client system obtains the second local data using a file system (e.g., a Windows file systems) associated with the point of sale system. For example, the second client system may listen for, and/or detect, a create event (or other file system events and/or operating systems events). In response to detecting the create event, the second client system may connect directly to the file system folder containing the created data (e.g., second local data), and pull the local data. This may, for example, ensure that local data is pulled immediately after being generated, and also may reduce and/or prevent duplicate data.

In some embodiments, the second local data is obtained during a persistent authenticated session between the second client system and the second point of sale system. For example, the second client system may log-in to the second point of sale system using operating systems credentials (e.g., username and password of the Windows computer implementing second point of sale system) associated with the second point of sale system. A cookie or other session token may be renewed or refreshed by the second client system to maintain a persistent connection between the second client system and the second point of sale system. In some embodiments, the point of sale interface engine performs log-in, authentication, and/or maintains the persistent connection.

In some embodiments, the first point of sale system and/or the second point of sale system are not capable of WAN connections. For example, the first and second point of sale systems may only have cable connections for direct local-area networking.

In step 506, the central server system filters the first local data and the second local data based on one or more filtering rules (e.g., filtering rules 324) associated with the first point of sale system and the second point of sale system. For example, filtering may include removing duplicate data entries from the first local data caused by a periodic pull used by the first client system to obtain the first local data from the point of sale system. In some embodiments, a filtering engine (e.g., filtering engine 304) filters the first and second local data of local data (e.g., local data 140) stored in a central server system datastore (e.g., central server system datastore 316).

In step 508, the central server system identifies a first remote target system (e.g., a brand system 110 or a distributor system 112). For example, the central server system may identify the first remote target system based on a request for data (e.g., a report) by the first remote target system and/or other system associated with a same entity as the first remote target system. For example, the central server system may identify a Coca-Cola target system in response to receiving a request for a report by the Coca-Cola target system and/or other Coca-Cola system. In some embodiments, the filtering engine and/or a reporting engine (e.g., reporting engine 308) identifies the first remote target system.

In step 510, the central server system selects at least a portion of the filtered data (e.g., filtered data 320). The selected filtered data may include filtered data associated with the first owner entity and other filtered data associated with the second owner entity. In some embodiments, the filtering engine and/or reporting engine selects the filtered data (e.g., based on a request for a report). For example, in some embodiments, the request specifies one or more variables, e.g., manufacturer, brand, product type, product category, retail store identifier, geographic location, and/or specific set of uniform product codes (UPCs), and the at least a portion of the filtered data is selected based on the variables specified. The central server system selects the relevant subset of the local data 140 and/or filtered local data 320. For example, a distributor may want to want to know how many items were sold in the state of Oregon and/or in a northwest region of the United States. The request may identify a geographic region (e.g., particular state, county, town, and/or sets thereof), and the relevant subset of local or filtered data may be selected based on the geographic region. The corresponding report may indicate the information in one or more varying levels of granularity.

In step 512, the central server system generates target-formatted data (e.g., target-formatted data 322) from the selected filtered data based on a first interface (e.g., central server system interface 144) associated with the first remote target system. For example, the first interface may define format requirements (e.g., data types, table structures, field names, object properties) for data (e.g., reports) sent to the remote target system. The target-formatted data may have a third data format associated with the first remote target system. The third data format may be a tabular format, object-oriented format, and/or the like. The third data format be different and/or the same as the first and/or second data formats. The target-formatted data may appear to be associated with a single owner entity (e.g., a “Skupos” entity). This may, for example, allow the remote target system to receive and/or process local data generated by many different and disparate point of sale systems that otherwise would not be provided to the remote target system. In some embodiments, a formatting engine (e.g., formatting engine 306) generates the target-formatted data.

In step 514, the central server system provides the target-formatted data to the first remote target system. In some embodiments, the communication engine provides the target-formatted data over the WAN using the first interface and/or other interface associated with the remote target system. For example, the first interface may define one or more communication protocols (e.g., APIs) for the remote target system.

In some embodiments, a client system may be connected to multiple point of sale systems and obtain local data from multiple point of sale systems. For example, the central server system may obtain third local data from the first client system connected to the central server system via the WAN. The third local data may be generated by a third point of sale system (e.g., a Verifone system or a Gilbarco system) connected to the first client system via the first LAN. The third point of sale system may be associated with the first owner entity, and the third local data being may be obtained from the third point of sale system by the first client system via the first LAN. The third local data may be generated by the third point of sale system according to the first data format. The central server system may filter the third local data, and generate a first report (e.g., report 326) associated with the first and third filtered local data. The central server system may provide the first report to an owner system (e.g., owner system 114). For example, the central server system may generate a report summarizing transactions processed by the first and third point of sale systems. In some embodiments, the reporting engine generates the report.

In some embodiments, the central server system obtains fourth local data from a third client system connected to the central server system via the WAN. The fourth local data may be generated by a fourth point of sale system (e.g., a Verifone or Gilbarco point of sale system) connected to a third client system via a third LAN. The fourth point of sale system may associated with the first owner entity (e.g., located in another retail store owned by Joe Smith). The fourth local data may be obtained from the fourth point of sale system by the fourth client system via the third LAN. The fourth local data may be generated by the fourth point of sale system according to the second format. The central server system may filter the fourth local data (e.g., in the same or similar manner as the first, second, and/or third local data). The central server system may also generate a second report (e.g., report 326) associated with the first filtered local data, the third filtered local data, and the fourth filtered local data, and provide the second report to the owner system. For example, the second report may be generated in response to a query received from the owner system. The query may be processed by a query engine (e.g., query engine 310), and the query engine may trigger the reporting engine to generate the second report.

In some embodiments, the central server system may provide information to different remote target systems. For example, the central server system may provide information to other brand and/or distributor systems using interfaces particular to the respective brand and/or distributor systems. Accordingly, the central server system may identify a second remote target system (e.g., a Pepsi system) and select at least a second portion of the filtered data. The second portion of filtered data may be associated with the first point of sale system, the second point of sale system, the third point of sale system, and/or the fourth point of sale system. The central server system may generate second target-formatted data from the second portion of filtered data based on a second interface associated with the second remote target system (e.g., an interface associated with Pepsi). The second target-formatted data may have a fourth data format associated with the second remote target system. The fourth data format may be a tabular format, object-oriented format, and/or the like. The fourth data format be different and/or the same as the first, second, and/or third data formats. The second target-formatted data may appear to be associated with the single owner entity. The central server system may provide the second target-formatted data to the second remote target system.

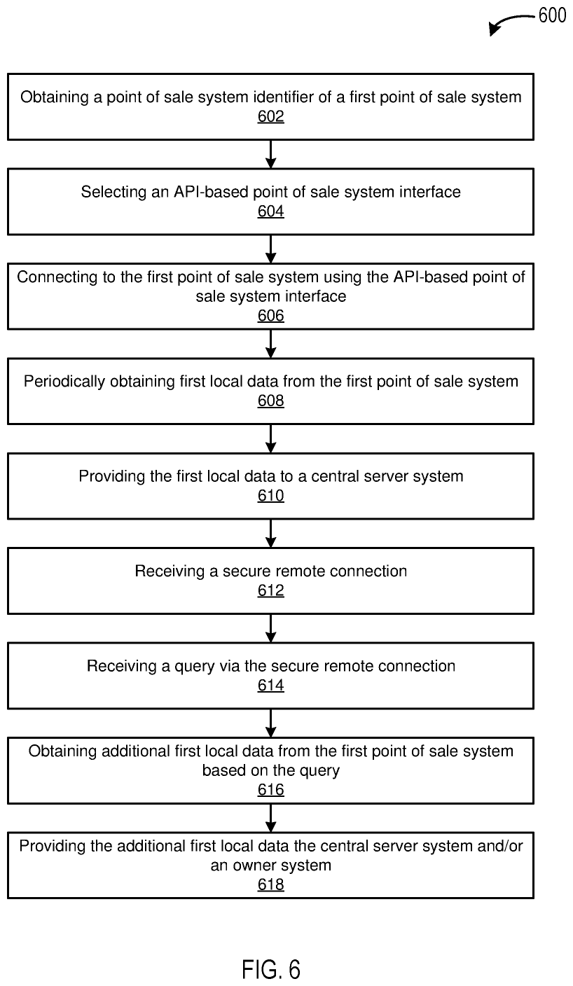

FIG. 6 depicts a flowchart of an example method 600 of operation of a client system connected to an API-based point of sale system according to some embodiments.

In step 602, a client system (e.g., client system 106-1) obtains a point of sale system identifier of a first point of sale system (e.g., first point of sale system 102). For example, the point of sale system identifier may be an Internet Protocol (IP) address. In some embodiments, a point of sale interface engine (e.g., point of sale interface engine 204) obtains the identifier of the first point of sale system. For example, a user may select and/or input an IP address through a graphical user interface presented to the user via the point of sale interface engine.

In step 604, the client system selects an API-based point of sale system interface (e.g., a point of sale interface 130). For example, the API-based point of sale system interface may be configured to hook into a first client system (e.g., first client system 102). In some embodiments, the point of sale interface engine selects the interface.

In step 606, the client system connects to the first point of sale system using the API-based point of sale system interface. In some embodiments, the point of sale interface engine and/or a communication engine (e.g., communication engine 212) connects to the first point of sale system over a LAN connection (e.g., a direct cable connection and/or a local Wi-Fi connection).

In step 608, the client system periodically obtains first local data (e.g., first local data 120). In some embodiments, a query engine (e.g., query engine 206) periodically obtains (e.g., every 15 minutes) the first local data over the LAN connection.

In step 610, the client system provides the first local data to a central server system (e.g., central server system 108). In some embodiments, the query engine and/or the communication engine provides the first local data to the central server system in response to obtaining the first local data and/or in one or more batches.

In step 612, the client system receives a secure remote connection. For example, the secure remote connection may comprise a virtual private network (VPN) connection between the client system and an owner system (e.g., owner system 114). A remote access engine (e.g., remote access engine 210) may receive the secure remote connection The secure remote connection may be a VPN connection and may be facilitated by a remote access interface (e.g., remote access interface 132). The secure remote connection may be between the client system and an owner system (e.g., owner system 114).

In step 614, the client system receives a query via the secure remote connection. For example, the client system may receive the query from the owner system. The query may be for particular first local data (e.g., first local data 120). For example, the query may be for a first local data having an associated file name corresponding to a particular date (e.g., August). In some embodiments, the query engine and/or the communication engine receives the query.

In step 616, the client system obtains additional first local data from the first point of sale system based on and/or in response to the query. In some embodiments, the point of sale interface engine and/or communication engine obtains the additional first local data in response to triggering from query engine.

In step 618, the client system provides to the additional local data to the owner system and/or the central server system. For example, the client system may provide the additional local data to the central server system for filtering, formatting, and/or generating a corresponding report, and the central server system may be provide some or all of that information to the owner system. In some embodiments, the query engine and/or the communication engine provide the additional first local data to the owner systems and/or the central server system over a communications network (e.g., communications network 116).

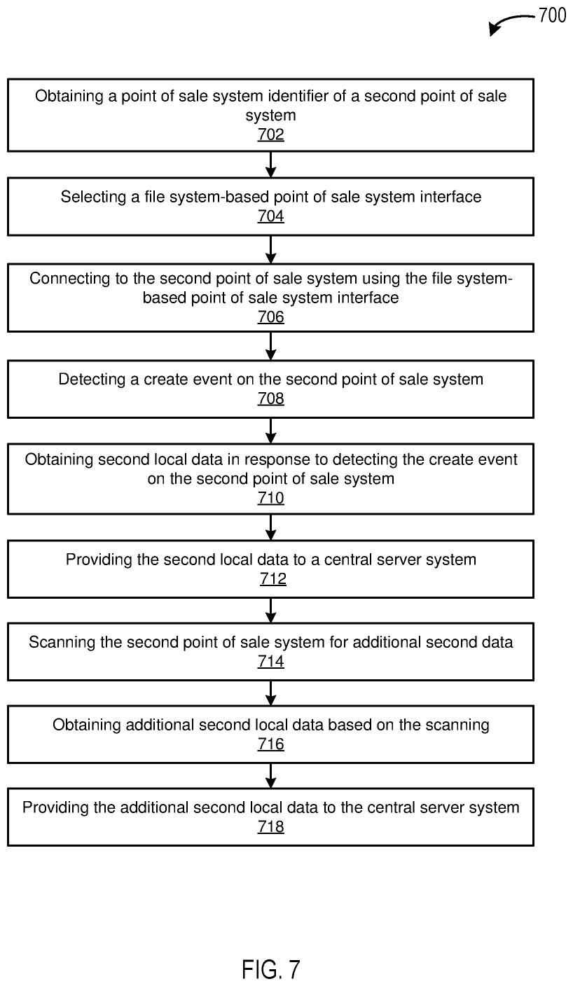

FIG. 7 depicts a flowchart of an example method 700 of operation of a client system connected to a file system-based point of sale system according to some embodiments.

In step 702, a client system (e.g., client system 106-N) obtains a point of sale system identifier of a second point of sale system (e.g., second point of sale system 104). In some embodiments, a point of sale interface engine (e.g., point of sale interface engine 204) obtains the identifier (e.g., an IP address).

In step 704, the client system selects a file system-based point of sale system interface (e.g., point of sale system interface 130). The file system-based interface may define authentication credentials (e.g., username and password) for accessing an operating system (e.g., Windows) of the computing device implementing the second point of sale system. In some embodiments, the point of sale interface engine selects the file system-based point of sale system interface.

In step 706, the client system connects to the second point of sale system using the file system-based interface. In some embodiments, the point of sale interface engine and/or a communication engine (e.g., communication engine 212) connects the client system to the second point of sale system over a LAN.

In step 708, the client system detects a create event on the second point of sale system. In some embodiments, an event detection engine (e.g., event detection engine 208) detects the create event.

In step 710, the client system obtains second local data (e.g., second local data 122) from a file system associated with the second point of sale system in response to detecting the create event. For example, the client system may obtain the local data from a Windows folder and/or directory. In some embodiments, a query engine (e.g., query engine 206) cooperating with the point of sale interface engine and/or the communication engine obtains the second local data over the LAN.

In step 712, the client system provides the second local data to a central server system (e.g., central server system 108) in response to obtaining the second local data. In some embodiments, the query engine and/or the communication engine provides the second local data to the central server system over a communication network (e.g., communications network 116).

In step 714, the client system scans the second point of sale system for additional second data. For example, the client system may scan at least a portion of the file system associated with the second point of sale system for additional second local data (e.g., missing data). For example, the client system may scan periodically (e.g., every 15 minutes). In some embodiments, the query engine scans the second point of sale system. Missing data may be determined by the central server system and may be expected data. For example, local data may be determined to have missing data if the local data has substantially fewer entries (e.g., a threshold number of few entries and/or ratio of fewer entries) entries than related entries (e.g., earlier entries on the same day of the week).

In step 716, the client system obtains additional second local data in response to, and/or based on, the scanning. In some embodiments, the query engine obtains the additional second local data.

In step 718, the client system provides the additional second local data to the central server system based on, and/or in response to, obtaining the additional second local data. In some embodiments, the query engine and/or communication engine provide the additional second data to the central server system.

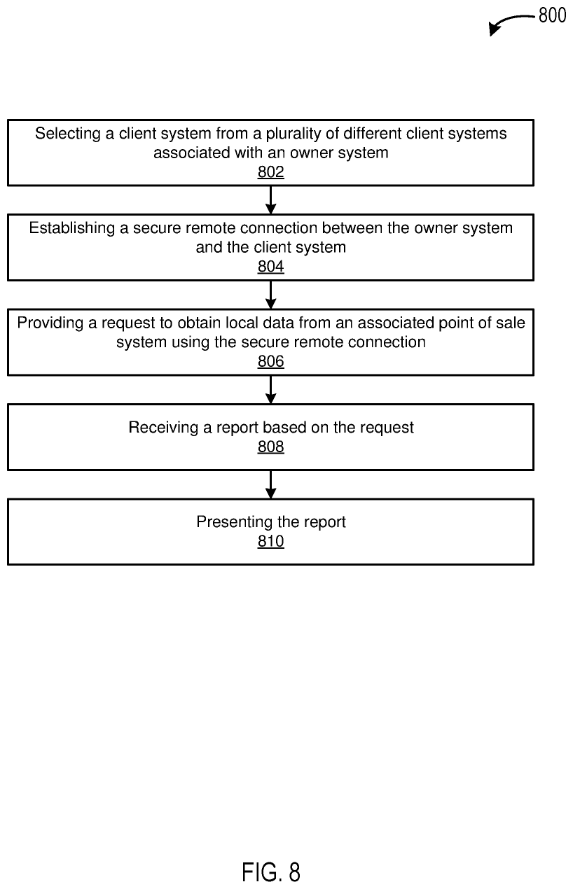

FIG. 8 depicts a flowchart of an example method 800 of an owner system according to some embodiments.

In step 802, an owner system (e.g., owner system 114) selects a client system (e.g., client system 106) from a plurality of different client systems associated with the owner system. For example, a presentation engine (e.g., presentation engine 404) may generate a GUI displaying a menu of client systems associated (e.g., owned and/or operated) with an owner entity, and the owner entity may select the client system. Each of the available client systems may be in different locations and/or different retail stores.

In step 804, the owner system establishes a secure remote connection with the client system. In some embodiments, a remote access engine (e.g., remote access engine 402) uses a remote access interface (e.g., remote access interface 150) to establish the secure remote connections.

In step 806, the owner system provides a request to obtain local data (e.g., local data 120 and/or local data 122) from an associated point of sale system (e.g., first point of sale system 102 or second point of sale system 104) using the secure remote connection. In some embodiments, owner systems generates and provides a request for a report (e.g., report 326). In some embodiments, a communication engine (e.g., communication engine 406) may generate and/or provide the request.

In step 808, the owner system receives a report (e.g., report 326) based on, and/or in response to, providing the request. For example, the communication engine may receive the report from a central server system (e.g., central server system 108).

In step 810, the owner system presents the report. In some embodiments, the presentation engine presents the report. For example, the presentation engine may generate and/or present a dashboard and/or other GUI presenting the report.

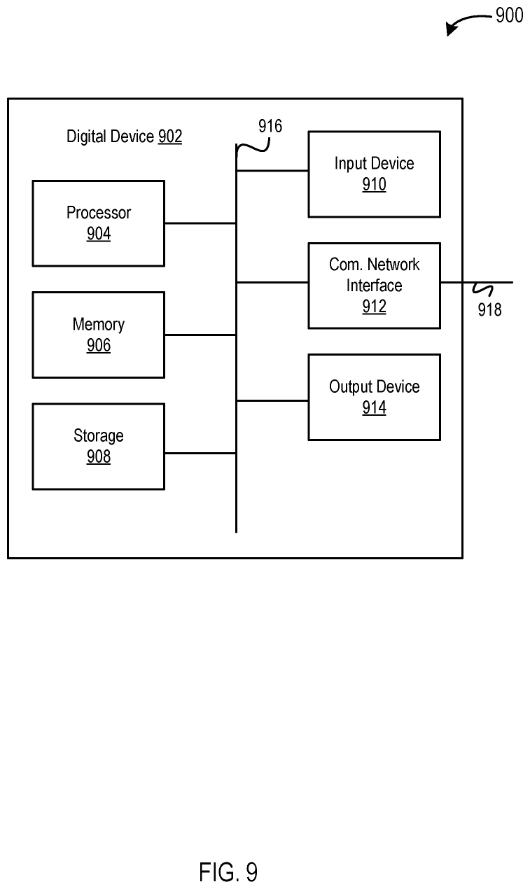

FIG. 9 depicts a diagram of an example computing device 902. Any of the systems, engines, datastores, and/or networks described herein may comprise an instance of one or more computing devices 902. In some embodiments, functionality of the computing device 902 may perform some or all of the functionality described herein. The computing device 902 comprises a processor 904, memory 906, storage 908, an input device 910, a communication network interface 912, and an output device 914 communicatively coupled to a communication channel 916. The processor 904 is configured to execute executable instructions (e.g., programs). In some embodiments, the processor 904 comprises circuitry or any processor capable of processing the executable instructions.

The memory 906 stores data. Some examples of memory 906 include storage devices, such as RAM, ROM, RAM cache, virtual memory, etc. In various embodiments, working data is stored within the memory 906. The data within the memory 906 may be cleared or ultimately transferred to the storage 908.

The storage 908 includes any storage configured to retrieve and store data. Some examples of the storage 908 include flash drives, hard drives, optical drives, cloud storage, and/or magnetic tape. Each of the memory system 906 and the storage system 908 comprises a computer-readable medium, which stores instructions or programs executable by processor 904.

The input device 910 is any device that inputs data (e.g., mouse and keyboard). The output device 914 outputs data (e.g., a speaker or display). It will be appreciated that the storage 908, input device 910, and output device 914 may be optional. For example, the routers/switches may comprise the processor 904 and memory 906 as well as a device to receive and output data (e.g., the communication network interface 912 and/or the output device 914).

The communication network interface 912 may be coupled to a network (e.g., network 108) via the link 918. The communication network interface 912 may support communication over an Ethernet connection, a serial connection (e.g., USB), a parallel connection, and/or an ATA connection. The communication network interface 912 may also support wireless communication (e.g., 802.11 a/b/g/n, WiMax, LTE, WiFi). It will be apparent that the communication network interface 912 may support many wired and wireless standards.

It will be appreciated that the hardware elements of the computing device 902 are not limited to those depicted in FIG. 9. A computing device 902 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 904 and/or a co-processor located on a GPU (e.g., NVIDIA).

It will be appreciated that an “engine,” “system,” “datastore,” and/or “database” may comprise software, hardware, firmware, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance.

The datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The systems, methods, engines, datastores, and/or databases described herein may be at least partially hardware-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

1. A central server system comprising:
one or more processors; and
memory storing instructions that, when executed by the one or more processors, cause the central server system to perform:
obtaining first local data from a first client system connected to the central server system via a wide-area network (WAN), the first local data generated by a first point of sale system connected to the first client system via a first local-area network (LAN), the first point of sale system being associated with a first owner entity, the first local data being obtained from the first point of sale system by the first client system via the first LAN, and the first local data being generated by the first point of sale system according to a first data format;
obtaining second local data from a second client system connected to the central server system via the WAN, the second local data generated by a second point of sale system connected to the second client system via a second LAN, the second point of sale system being associated with a second owner entity, the second local data being obtained from the second point of sale system by the second client system via the second LAN, and the second local data being generated by the second point of sale system according to a second data format;
filtering the first local data and the second local data based on one or more filtering rules associated with the first point of sale system and the second point of sale system;
identifying a first remote target system;
selecting at least a portion of the filtered data, the at least a portion of the filtered data including filtered data associated with the first owner entity and filtered data associated with the second owner entity;
generating target-formatted data from the selected filtered data based on a first interface associated with the first remote target system, the target-formatted data having a third data format associated with the first remote target system, the target-formatted data appearing to be associated with a single owner entity; and
providing the target-formatted data to the first remote target system.

2. The central server system of claim 1, wherein the first client system obtains the first local data using one or more application programming interfaces (APIs) associated with the first point of sale system.

3. The central server system of claim 1, wherein the second client system obtains the second local data using a file system associated with the second point of sale system.

4. The central server system of claim 1, wherein the first point of sale system and the second point of sale system are not capable of WAN connections.

5. The central server system of claim 1, wherein the filtering includes removing duplicate data entries from the first local data caused by a periodic pull used by the first client system to obtain the first local data from the first point of sale system.

6. The central server system of claim 3, wherein the second client system obtains the second local data in response to detecting a create event associated with the file system.

7. The central server system of claim 1, wherein the instructions further cause the system to perform:
obtaining third local data from the first client system connected to the central server system via the WAN, the third local data generated by a third point of sale system connected to the first client system via the first LAN, the third point of sale system being associated with the first owner entity, the third local data being obtained from the third point of sale system by the first client system via the first LAN, and the third local data being generated by the first point of sale system according to the first data format;
filtering the third local data;
generating a first report associated with the first local data and the third filtered local data; and
providing the first report to an owner system.

8. The central server system of claim 7, wherein the instructions further cause the system to perform:
obtaining fourth local data from a third client system connected to the central server system via the WAN, the fourth local data generated by a fourth point of sale system connected to the third client system via a third LAN, the fourth point of sale system being associated with the first owner entity, the fourth local data being obtained from the fourth point of sale system by the third client system via the third LAN, and the fourth local data being generated by the fourth point of sale system according to the second data format;
filtering the fourth local data;
generating, in response to a query received from the owner system, a second report associated with the first filtered local data, the third filtered local data, and the fourth filtered local data; and
providing the second report to the owner system.

9. The central server system of claim 8, wherein the instructions further cause the system to perform:
identifying a second remote target system;
selecting at least a second portion of the filtered data, the at least a portion of the filtered data including filtered data associated with the first point of sale system, the second point of sale system, the third point of sale system, and the fourth point of sale system;
generating second target-formatted data from the second portion of the filtered data based on a second interface associated with the second remote target system, the second target-formatted data having a fourth data format associated with the second remote target system, the second target-formatted data appearing to be associated with the single owner entity; and
providing the second target-formatted data to the second remote target system.

10. The central server system of claim 4, wherein the first LAN comprises a first direct cable connection between the first point of sale system and the first client system, and the second LAN comprises a second direct cable connection between the second point of sale system and the second client system.

11. The central server system of claim 1, wherein the first local data is obtained in response to a periodic pull request during a persistent authenticated session between the first client system and the first point of sale system.

12. The central server system of claim 1, wherein the first remote target system is identified in response to a request for a report associated with the first remote target system.

13. The central server system of claim 12, wherein the request identifies one or more variables, and the at least a portion of the filtered data is selected based on the one or more variables.

14. A method being implemented by a central server system including one or more physical processors and storage media storing machine-readable instructions, the method comprising:
obtaining first local data from a first client system connected to the central server system via a wide-area network (WAN), the first local data generated by a first point of sale system connected to the first client system via a first local-area network (LAN), the first point of sale system being associated with a first owner entity, the first local data being obtained from the first point of sale system by the first client system via the first LAN, and the first local data being generated by the first point of sale system according to a first data format;
obtaining second local data from a second client system connected to the central server system via the WAN, the second local data generated by a second point of sale system connected to the second client system via a second LAN, the second point of sale system being associated with a second owner entity, the second local data being obtained from the second point of sale system by the second client system via the second LAN, and the second local data being generated by the second point of sale system according to a second data format;
filtering the first local data and the second local data based on one or more filtering rules associated with the first point of sale system and the second point of sale system;
identifying a first remote target system;
selecting at least a portion of the filtered data, the at least a portion of the filtered data including filtered data associated with the first owner entity and filtered data associated with the second owner entity;
generating target-formatted data from the selected filtered data based on a first interface associated with the first remote target system, the target-formatted data having a third data format associated with the first remote target system, the target-formatted data appearing to be associated with a single owner entity; and
providing the target-formatted data to the first remote target system.

15. The method of claim 14, wherein the first client system obtains the first local data using one or more application programming interfaces (APIs) associated with the first point of sale system.

16. The method of claim 14, wherein the second client system obtains the second local data using a file system associated with the point of sale system.

17. The method of claim 14, wherein the first point of sale system and the second point of sale system are not capable of WAN connections.

18. The method of claim 14, wherein the filtering includes removing duplicate data entries from the first local data caused by a periodic pull used by the first client system to obtain the first local data from the point of sale system.

19. The method of claim 16, wherein the second client system obtains the second local data in response to detecting a create event associated with the file system.

20. The method of claim 14, further comprising:
obtaining third local data from the first client system connected to the central server system via the WAN, the third local data generated by a third point of sale system connected to the first client system via the first LAN, the third point of sale system being associated with the first owner entity, the third local data being obtained from the third point of sale system by the first client system via the first LAN, and the third local data being generated by the first point of sale system according to the first data format;
filtering the third local data;
generating a first report associated with the first filtered data and the third filtered local data; and
providing the first report to an owner system.

21. The method of claim 20, further comprising:
obtaining fourth local data from a third client system connected to the central server system via the WAN, the fourth local data generated by a fourth point of sale system connected to the third client system via a third LAN, the fourth point of sale system being associated with the first owner entity, the fourth local data being obtained from the fourth point of sale system by the third client system via the third LAN, and the fourth local data being generated by the fourth point of sale system according to the second data format;
filtering the fourth local data;
generating, in response to a query received from the owner system, a second report associated with the first filtered local data, the third filtered local data, and the fourth filtered local data; and
providing the second report to the owner system.

22. The method of claim 21, further comprising:
identifying a second remote target system;
selecting at least a second portion of the filtered data, the at least a portion of the filtered data including filtered data associated with the first point of sale system, the second point of sale system, the third point of sale system, and the fourth point of sale system;
generating second target-formatted data from the second portion of the filtered data based on a second interface associated with the second remote target system, the second target-formatted data having a fourth data format associated with the second remote target system, the second target-formatted data appearing to be associated with the single owner entity; and
providing the second target-formatted data to the second remote target system.

23. The method of claim 17, wherein the first LAN comprises a first direct cable connection between the first point of sale system and the first client system, and the second LAN comprises a second direct cable connection between the second point of sale system and the second client system.

24. The method of claim 14, wherein the first local data is obtained in response to a periodic pull request during a persistent authenticated session between the first client system and the first point of sale system.

25. The method of claim 14, wherein the first remote target system is identified in response to a request for a report associated with the first remote target system.

26. The method of claim 25, wherein the request identifies one or more variables, and the at least a portion of the filtered data is selected based on the one or more variables.
